(19) United States
(12) Patent Application Publication
(10) Pub. No.: US 2014/0146006 A1
(43) Pub. Date: May 29, 2014

(54) METHOD FOR DETECTING AN OBJECT OF INTEREST IN A DISTURBED ENVIRONMENT, AND GESTURE INTERFACE DEVICE IMPLEMENTING SAID METHOD

(71) Applicant: Bruno Luong, Nimes (FR)

(72) Inventor: Bruno Luong, Nimes (FR)

(73) Assignee: Nanotec Solution, Nîmes (FR)

(21) Appl. No.: 13/883,377

(22) PCT Filed: Oct. 28, 2011
(86) PCT No.: PCT/FR2011/052533

§ 371 Date: Jul. 29, 2013

(30) Foreign Application Priority Data
Nov. 8, 2010 (FR) 1059203

(51) Int. Cl. G06F 3/044

(52) U.S. Cl. CPC G06F 3/044
USPC 345/174

(57) ABSTRACT

A method is provided for detecting at least one object of interest moving in an environment, and implements at least one capacitive coupling measurement electrode with the object of interest and with one or more other “disrupting” objects present in the environment. Included in the method, for at least one of the measurement electrodes, are steps of: (i) measuring the total capacity between the measurement electrode and the environment; (ii) storing the total capacity; (iii) calculating a leakage capacity due to the disrupting objects on the basis of predetermining a minimum value within a history of pre-stored total capacity measurements; (iv) calculating a capacity of interest due to the objects of interest while subtracting the leakage capacity from the total measured capacity; and (v) processing the thus-calculated capacity of interest to produce information for detecting the object or objects of interest. Also included is a device implementing the present method.

### TECHNICAL FIELD

The present invention relates to a method for detecting objects of interest in a disturbed environment, applicable to gesture interfaces. It also relates to a gesture interface device implementing the method.

The field of the invention is more particularly but not limited to that of tactile and 3D capacitive surfaces used for man-machine interface controls.

### STATE OF PRIOR ART

Communication and working apparatuses increasingly use a tactile control interface such as a pad or screen. For example mobile phones, smartphones, tactile screen computers, pads, PC, mice, touchscreens, projection screens . . . can be mentioned

A large number of these interfaces use capacitive technologies. The tactile surface is equipped with conducting electrodes connected to electronic means which allow measuring the variation of the capacitances appearing between the electrodes and the object to be detected to execute a command.

Capacitive techniques currently implemented in tactile interfaces most often use two layers of conducting electrodes in the form of rows and columns. The electronics measures the coupling capacitances which exist between these rows and columns. When a finger is very close to the active surface, the coupling capacitances in the vicinity of the finger are changed and the electronics can thus locate the 2D position (YX) in the plane of the active surface.

These technologies allow detecting the presence and the position of the finger through a dielectric. They have the advantage to allow a very high resolution in the localization in the (XY) plane of the sensitive surface of one or more fingers.

However, these techniques have the drawback to generate by principle high leakage capacitances at the level of the electrodes and the electronics.

These leakage capacitances can further drift over time due to aging, material deformation, or the effect of the variation in the surrounding temperature. These variations can degrade the sensitivity of the electrodes, or even inopportunely trigger commands. One solution is to correct these drifts. Document US2010/0013800 to Elia et al. is known, which provides a method for correcting these parasitic capacitances by stimulating the electrodes and measuring the parasitic capacitances. This method is however essentially applicable during calibration phases in a plant.

Techniques are also known which allows measuring the absolute capacitance which appears between electrodes and an object to be detected. Document FR 2 844 349 to Rozière for example is known, which discloses a proximity capacitive detector including a plurality of independent electrodes, which allows to measure the capacitance and distance between electrodes and an object in the vicinity thereof.

These techniques allow obtaining capacitance measurements between the electrodes and the objects with high resolution and sensitivity, allowing detecting for example a finger several centimetres or even ten centimetres distant. The detection can be made in three-dimensional space (XYZ) but also on a surface, in a plane (XY). These techniques give the opportunity to develop gesture interfaces actually contactless, and also enable the performance of tactile interfaces to be improved.

However, a new problem occurs by contrast with contact measurement techniques based on tactile surfaces, which is the effect of the environment. Indeed, the range of a conventional touchscreen is very low (in the order of a few millimetres at most in the air) and a change in the environment such as for example the approach of a hand, fingers or any object has only little effect on the performance and robustness of the tactile detection.

On the other hand, in techniques using absolute capacitance measurements such as for example described in FR 2 844 349, and capable of detecting the approach of an object at more than 10 cm, any displacement of a parasitic object at this distance can also be construed as the presence of the object to be detected, and trigger an undesired parasitic command.

A change in the environment is all the more important for all portable devices such as for example mobile phones, notebooks, laptops . . .

Having for example a cellular phone in one's left hand and making a (contactless) gesture command with one's right hand can turn out to be delicate from the point of view of the measurement because the left hand fingers can have a parasitic gesture action comparable with that of the right hand. Indeed, it is difficult or even impossible to discriminate fingers moving closer to the edge of the sensitive surface from a control finger of the right hand moving closer a few centimetres distant.

Another example relates to tactile and gesture capacitive screens of laptops. Setting the tilting of the screen moves the sensitive screen surface close to or away from the keyboard. This variation in getting closer or farther can be construed as the hand to be detected moving closer or farther. Moreover, since the keyboard area is very large, the sensitivity of the capacitive electrodes of the screen can change depending on the surface separating them from the keyboard. Indeed, the sensitivity of capacitive electrodes depends on their area but also on edge effects that can deviate or disturb the electrostatic field lines of the electrodes in question.

The presence of an inert object as for example an object on the desk in the vicinity of the capacitive touchscreen of a gesture interface can also significantly modify the response of the touchscreen. The inert object can also be the support for the capacitive touchscreen as for example a desk. This support can for example include more or less thick wood, or any other dielectric or electrically conductive material. These materials can modify the leakage capacitances due to the edge effects. Moving to a different place on a desk can also modify leakage capacitances due for example to the presence of feet under the desk, consisting of a dielectric surface.

Another example is the use of a gesture control in a vehicle where the change in the environment can be the displacement of a gearshift lever, a hand brake, the presence of a passenger, setting the seat . . .

The object of the present invention is to provide a gesture interface control method and device, enabling correcting the disturbing effects of the environment and improving the detection of commands.

### DISCLOSURE OF THE INVENTION

This purpose is achieved with a method for detecting an object or objects of interest moving in an environment, implementing at least one measurement electrode in capacitive coupling with said object or objects of interest and with one or more other so-called “disturbing” objects present in this environment, characterised in that it includes, for at least one of said measurement electrodes, steps of:

measuring the total capacitance between said measurement electrode and said environment,

storing said total capacitance,

calculating the leakage capacitance due to said disturbing objects, on the basis of a determination of a minimum value within a history of pre-stored total capacitance measurements,

calculating a capacitance of interest due to said object or objects of interest, by subtracting said leakage capacitance from the total measured capacitance, and

processing said thus-calculated capacitance of interest so as to produce an information of detection of said object or objects of interest.

The method according to the invention can further include a step of updating the history of measurements, such that said history of measurements includes total capacitances measured during a period of time corresponding to a sliding time window with respect to the measurement time, of a predetermined duration.

According to embodiments,

the duration of the sliding time window can be determined as being higher than a mean presence duration of the objects of interest in the vicinity of the measurement electrode;

the duration of the sliding time window can be between one and ten seconds.

In a non-limiting way, any other duration value for the sliding time window can also be used depending on the type of environment. This duration can be lower than one second for very dynamic applications, or on the contrary in the order of a few tens of seconds to several minutes for a very static environment.

The method according to the invention can further include a step of adjusting the duration of the sliding time window depending on the variation dynamics of the measurements.

The method according to the invention can further include steps of:

gathering the latest stored measurements as a time sub-window having a duration lower than the sliding time window,

determining the minimum value in this sub-window, and

replacing measurements corresponding to said sub-window by said minimum value in the history of measurements.

According to embodiments:

determining a minimum value within the history of measurements can include using an optimal minimum/maximum filtering algorithm, with a substantially constant calculation time;

calculating the capacitance of interest can include calculating a combination of the leakage capacitance and of the total measured capacitance. This combination can be a linear combination.

The method according to the invention can further include:

a prior calibration step including, for at least one measurement electrode, determining an initial leakage capacitance by measuring the total capacitance of the measurement electrode in the absence of an object of interest,

a step of adding, as a combination, this initial leakage capacitance to the subsequently determined leakage capacitances, wherein this combination can be a linear combination.

The method according to the invention can be implemented for a plurality of measurement electrodes differently depending on said electrodes.

According to another aspect, there is provided a gesture interface device implementing the method for detecting objects of interest in a disturbed environment of the invention, said gesture interface being made from objects of interest being gesture-moved in said environment further including disturbing objects, said device comprising at least one measurement electrode capable of detecting objects by capacitive coupling between said measurement electrode and said objects, characterised in that it further includes, for at least one measurement electrode:

electronic means for measuring the total capacitance between said measurement electrode and said environment,

means for storing said total capacitance,

means for calculating the leakage capacitance due to the disturbing objects, including means for determining a minimum value within a history of pre-stored total capacitance measurements,

means for calculating a capacitance of interest due to the objects of interest, while subtracting said leakage capacitance from the total measured capacitance, and

means for processing said thus-calculated capacitance of interest, arranged to deliver an information of detection of said object or objects of interest.

According to embodiments:

the device can further include a substantially planar surface comprising a plurality of measurement electrodes;

the measurement electrodes can comprise a material substantially transparent to light.

According to another aspect, there is provided a system of one of the following categories: phone, computer, computer peripheral, display screen, dashboard, control panel, implementing a capacitive detection method according to the invention.

According to yet another aspect, there is provided a system of one of the following categories: phone, computer, computer peripheral, display screen, dashboard, control panel, comprising a gesture interface device according to the invention.

### DESCRIPTION OF THE FIGURES AND EMBODIMENTS

Further advantages and features of the invention will appear upon reading the detailed description of implementations and embodiments in no way limiting, and the following appended drawings wherein:

FIG. 1 illustrates the influence of the environment on the tactile screen type gesture control device,

FIG. 2 illustrates the measurement of capacitances with the method according to the invention,

FIG. 3 shows an enlarged view of FIG. 2 enabling the leakage capacitance calculated with the method according to the invention to be viewed.

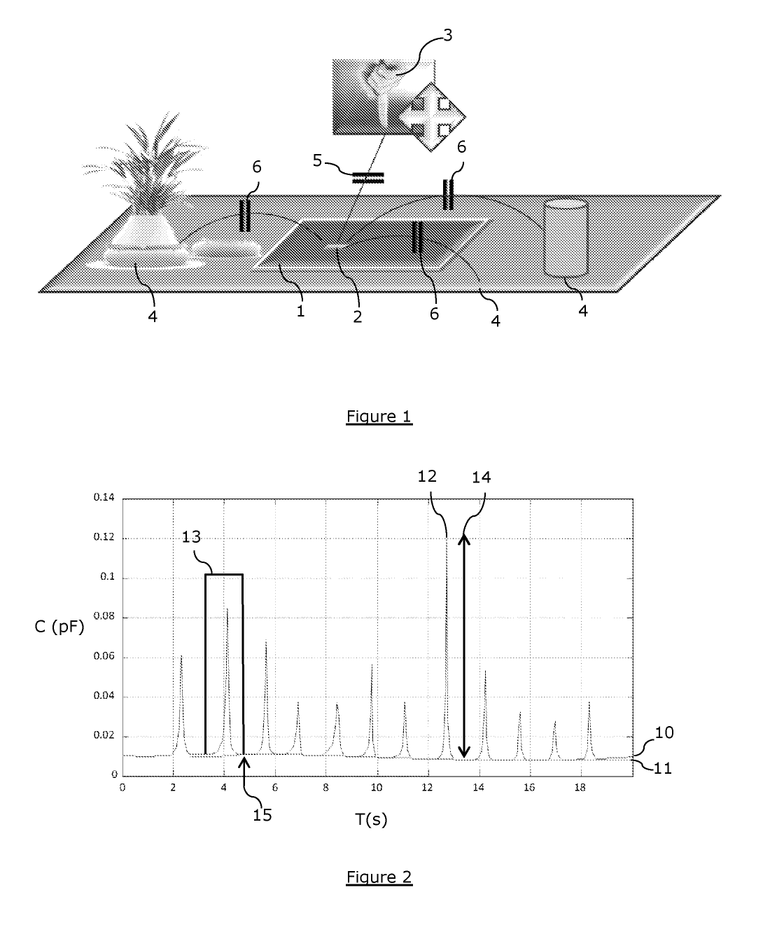

FIG. 1 presents an exemplary embodiment of a gesture control interface device according to the invention integrated in a computer or phone (smartphone) tactile screen. The interface device 1 comprises a plurality of capacitive electrodes 2 arranged such as to substantially cover its surface. For the sake of clarity, only one capacitive electrode 2 is represented in FIG. 1. The capacitive electrodes 2 and their control electronics are made according to a mode of implementation described in FR 2 844 349. The control electronics includes means for exciting the electrodes 2 at an AC voltage and capacitance measurement means having a very high sensitivity based on a floating bridge electronics. The electrodes 2 are sequentially interrogated through a polling device. The electronics is designed such as to substantially perfectly remove capacitive couplings between the electrodes 2, or between the electrodes 2 and parts of the interface device 1 which are subjected to another electric potential.

When an object of interest such as a finger 3 moves closer to an electrode 2, a capacitive coupling is set up therebetween. The corresponding capacitance 5 is measured by the control electronics. If the area of the electrode 2 is known, the measurement of this capacitance 5 enables the distance between the electrode 2 and the objet 3 to be measured.

In the absence of objects in the vicinity of the sensitive surface of the control device 1, the capacitance measured by each electrode 2 is close to zero, to the nearest edge effects and to the nearest imperfection of the sensitive surface and the electronics. These residual capacitances are called C∞. These residual capacitances can also be low value capacitances which correspond to the effect of the object of interest 3 when its distance is considered as out of reach of the measurement electrodes 2 or beyond a maximum detection distance.

In a much higher detrimental way for the applications considered, the residual capacitances C∞ can also be due to the presence of objects 4 in the vicinity of the interface device 1. In this case, leakage capacitances 6 are set up, the order of magnitude of which can be compared to that of the capacitance 5 due to the object of interest 3, and which thus can cause significant measurement errors.

One purpose of the present invention is precisely to provide a method allowing to discriminate the variations in the environment 4 from the presence of the object to be detected 3 so as to improve its detection and thus avoid wrong commands.

This discrimination exploits the fact that the object or objects of interest (or even called control objects in the following) 3 is (are) moving, even slowly, or is (are) static only during short time intervals, whereas the environment 4 changes more slowly, or on longer time intervals, or even remains inert.

More precisely, the correction lies on exploiting some specific aspects of the environment, which for example includes static objects 4 side by side in the vicinity of the capacitive interface device 1:

the capacitance of the electrode 2 of FIG. 1 increases with the presence of an object of interest 3 or of the environment 4. If CE1, CE2 and CE3 are the leakage capacitances 6 of the objects of the environment 4 and Cobj the capacitance 5 of the object of interest 3, the capacitance measured by the electrode 2 is:

C=CE1+CE2+CE3+Cobj; (Eq. 1)

for a gesture detection type application, a typical object of interest 3 such as a finger or a hand has relatively rapid movements with respect to the objects 4 considered as belonging to the environment.

The solution is to assess in real time, or in a changing manner over time, a map of leakage capacitances C∞ in order to correct the assessment of the position of the control object 3.

The leakage capacitance C∞ for a given electrode 2, by taking k objects of the environment 4 into account, can be expressed as follows:

C∞=CE1+CE2+ . . . +CEk. (Eq. 2)

This assessment is continuously updated to take changes in the environment into account, for example in case of movement of the interface device 1 or appearance of new objects 4 in the vicinity thereof.

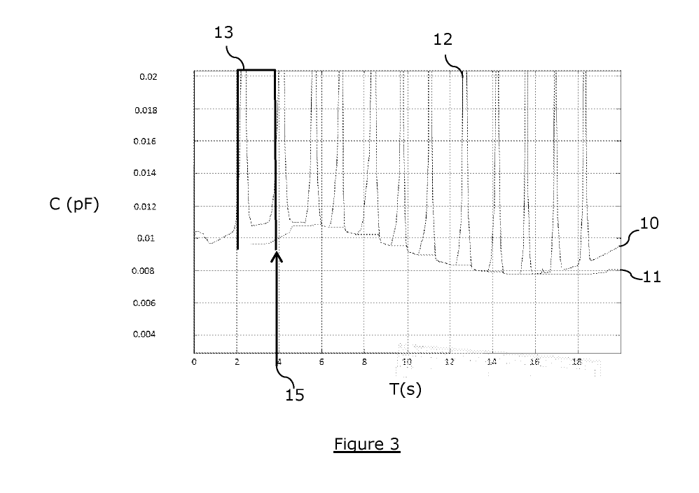

In reference to FIGS. 2 and 3, a method enabling the map C∞ to be dynamically assessed will now be described, during the use of the interface device 1.

The curve 10 shows a measurement of the total capacitance Ctot for an electrode 2 of the interface device 1. Peaks 12 correspond to the times when an object of interest 3 moves closer to the electrode 2. The curve 10 is representative of the situation wherein for example a finger 3 moves closer and periodically comes in the vicinity or in contact with the surface of the interface device 1, to “click” or actuate virtual keys.

The electrode 2 measures a total capacitance C, the contribution of which due to the object Cobj corresponds to the height 14 of the peaks 12.

A time window 13 is selected, the width or time duration Tm of which is substantially greater than the duration during which the object of interest 3 can remain still, but smaller than the period over which the environment can change. The time duration Tm must be in particular greater than the typical duration of a gesture (movement of the object of interest 3) so as to be able to discriminate the variations in capacitance due to a change of the object of interest 3 and those due to other objects 4 considered as belonging to the environment. The time window 13 is represented in FIGS. 2 and 3 relative to a measurement time (or present time) 15.

The capacitances C sampled in the past in this time window 13, up to the present time 14, are stored.

The value of the leakage capacitance C∞ at the present time 15 is determined as being the smallest capacitance value C stored during this time window 13.

The window 13 is sliding over time, meaning that the stored values are periodically updated (at each acquisition for example) to only retain a history of measurements having the duration Tm.

In practice, in the interface device 1, the capacitance C(t) of each electrode 2 is periodically measured with a time sampling Δt enabling gestures to be detected.

For each electrode for which the method according to the invention is applied, the N latest measured capacitance measurements, corresponding to the duration Tm of the sliding time window, are retained in a digital storage area of the device, and used to assess the leakage capacitance C∞. At each new measurement, the oldest of the N stored measurements is erased whereas the latest measurement is stored.

Since C∞≦C, the leakage capacitance C∞ at the measurement time t is calculated as a function of the stored capacitances C(s):

C∞(t)=min{C(s)}, (Eq. 3)

where min{} is the search operator for the minimum, and s belongs to the time interval [t−Tm,t].

By taking the time sampling into account, the leakage capacitance of the environment can be written as:

C∞(t)=min{C(t−(n−1)·Δt), C(t−(n−2)·Δt), . . . , . . . , C(t−2)·Δt), C(t−Δt), C(t)}. (Eq. 4)

The determination of this leakage capacitance C∞ thus implies a filtering operation by a minimum operator, or minimum filtering.

This minimum filtering has an adaptive behaviour being non-symmetric with respect to the changes in the environment:

if a new object 4 of the environment appears and/or if an object of interest 3 moves closer to the detection surface, the instantaneous capacitance C increases. In this case, the filter “waits” until this increase lasts at least all the duration Tm of the sliding window 13 before raising the value of the leakage capacitance C∞ in accordance with equation 3 or 4. By judiciously selecting this duration Tm, it is thus avoided that objects of interest 3 are taken into account in calculating the leakage capacitance C∞;

on the contrary, in the case where an object 4 of the environment disappears and/or an object of interest 3 moves away from the detection surface, the instantaneous capacitance C decreases, and the capacitance C∞ decreases almost instantaneously under the action of the minimum filter. Thus, the detection sensitivity is instantaneously adjusted. It is one of the advantages of the method proposed.

This distinction is achieved thanks to the consideration of the difference between the variation time constants of Cobj and C∞ and to the judicious selection of the width Tm of the window 13.

The curve 11 shows the change over time in the leakage capacitance C∞, as calculated by equation 4.

The selection of the width of the time window Tm depends on the apparatus type to be controlled and its operating mode.

In the case where the interface device 1 equips a cellular phone with a capacitive touch and gesture screen, the commands are relatively dynamic. The slowest commands are for example the selection of an icon on the screen to move or remove it. The action is then to fix the finger during at least 1 second to carry out the selection of the icon.

A time window having a duration of 2-10 seconds, or even 1-10 seconds, is suitable for this type of apparatus in order to retain the possibility to select an icon while integrating the environment correction.

Once the leakage capacitance C∞ is assessed, the capacitance due to the presence of the object of interest 3 is calculated as follows:

Cobj(t)=C(t)−C∞(t). (Eq. 5)

This environment effect-corrected capacitance 14 can then be conventionally used to detect the position or gesture of the object of interest 3.

According to alternative embodiments, in order to quickly calculate the leakage capacitance C∞(t) by optimising use of calculation resources, minimum/maximum filtering algorithms with optimal calculation time complexity can be used. Several algorithms of this type are found in the literature, which share the fact that the number of comparisons remains substantially constant regardless of the width of the time window selected.

The following algorithms are in particular usable within the scope of the invention:

M. Van Herk, “A fast algorithm for local minimum and maximum filters on rectangular and octagonal kernels”, Pattern Recogn Lett 13(7), pages 517-521, 1992;

J. Gil, R. Kimmel, “Efficient Dilation, Erosion, Opening and Closing Algorithms” IEEE Trans Pattern Anal Mach Intell 24(12), pages 1606-1617, 2002;

D. Lemire, “Streaming Maximum-Minimum Filter Using No More than Three Comparisons per Element”, Nordic Journal of Computing, 13(4), pages 328-339, 2006.

These algorithms enable the calculation time to be minimized, but require to store in memory the capacitances measured throughout the duration Tm of the sliding window 13.

According to alternative embodiments, a compromise can be made on the calculation time and the storage space. In this case, the sliding window 13 including N measurements is subdivided into M non-overlapping sub-windows, having the respective lengths n1, n2, . . . , nM, with N=n1+n2+ . . . +nM, and M<<N.

The calculation of the minimum in the last sub-window, currently filled, can be performed either by scrolling again at each iteration (corresponding to an acquisition for measuring the capacitance C) through the already stored values of the sub-window, or by keeping in memory the smallest value at each iteration.

For each complete sub-window included in the time window 13, only the minimum value is kept in memory, which is erased when the time interval covered by the sub-window becomes older, with respect to the acquisition time, than Tm.

The minima on all the sub-windows can be compared by using the abovementioned optimum algorithms. In this case, the storage area requires a dimension M (and no longer N).

According to alternative embodiments:

the time width Tm of the window 13 can be adapted as a function of the environment type autonomously by using a specific algorithm by taking the change of this environment over time into account from the measurements. It can also be manually adapted;

the calculation of the capacitance of interest Cobj can include a linear combination of the total C and leakage C∞ capacitances, or any other function of C and C∞;

the assessment of the capacitance C∞ with the minimum filtering as described in equation (4) can be combined with another calibration map of the leakage capacitance C∞′, determined beforehand and stored, for example from a calibration in a factory. This combination can be a linear combination, with a gain and offset factor, or any other combination. This enables too abrupt variations in the sensitivity of the capacitive detection to be avoided;

the method can be implemented in a similar or different way for the different electrodes 2 of the interface device 1. In particular, it can be implemented differently for the electrodes located at the periphery of the sensitive surface of the device 1, which are naturally more sensitive to changes in the environment. A quicker correction, with a window 13 having a shorter time width Tm, can be applied to these electrodes;

the invention can be implemented with any type of capacitive measurement electronics enabling capacitive leakages to be restricted.

Of course, the invention is not restricted to the examples just described and numerous modifications can be provided to these examples without departing from the scope of the invention.

1. A method for detecting an object or objects of interest moving in an environment, comprising: implementing at least one measurement electrode in capacitive coupling with said object or objects of interest and with one or more other so-called “disturbing” objects present in this environment; for at least one of said measurement electrodes, implementing steps of:
measuring the total capacitance between said measurement electrode and said environment;
storing said total capacitance;
calculating the leakage capacitance due to said disturbing objects, on the basis of a determination of a minimum value within a history of pre-stored total capacitance measurements;
calculating a capacitance of interest due to said object or objects of interest, by subtracting said leakage capacitance from the total measured capacitance; and
processing said thus-calculated capacitance of interest so as to produce an information of detection of said object or objects of interest.

2. The method according to claim 1, characterised in that it further includes a step of updating the history of measurements, such that said history of measurements includes total capacitances measured during a period of time corresponding to a sliding time window with respect to the measurement time, of a predetermined duration.

3. The method according to claim 2, characterised in that the duration of the sliding time window is determined as being higher than a mean presence duration of the objects of interest in the vicinity of the measurement electrode.

4. The method according to claim 2, characterised in that the duration of the sliding time window is between one and ten seconds.

5. The method according to claim 2, characterised in that it further includes a step of adjusting the duration of the sliding time window depending on the variation dynamics of the measurements.

6. The method according to claim 2, characterised in that it further includes steps of:
gathering the latest stored measurements as a time sub-window having a duration lower than the sliding time window;
determining the minimum value in this sub-window; and
replacing measurements corresponding to said sub-window by said minimum value in the history of measurements.

7. The method according to claim 1, characterised in that determining a minimum value in the history of measurements includes using an optimal minimum/maximum filtering algorithm, with a substantially constant calculation time.

8. The method according to claim 7, characterised in that calculating the capacitance of interest includes calculating a combination of the leakage capacitance and the total measured capacitance.

9. The method according to claim 1, characterised in that it further includes:
a prior calibration step including, for at least one measurement electrode, determining an initial leakage capacitance by measuring the total capacitance of the measurement electrode in the absence of an object of interest; and
a step of adding, as a combination, this initial leakage capacitance to the subsequently determined leakage capacitances.

10. The method according to claim 1, characterised in that it is implemented for a plurality of measurement electrodes differently depending on said electrodes.

11. A gesture interface device implementing the method for detecting objects of interest in a disturbed environment according to claim 1, said gesture interface being made from objects of interest being gesture-moved in said environment further including disturbing objects, said device comprising: at least one measurement electrode capable of detecting objects by capacitive coupling between said measurement electrode and said objects, said device further including, for at least one measurement electrode:
electronic means for measuring the total capacitance between said measurement electrode and said environment;
means for storing said total capacitance;
means for calculating the leakage capacitance due to the disturbing objects, including means for determining a minimum value within a history of pre-stored total capacitance measurements;
means for calculating a capacitance of interest due to the objects of interest, while subtracting said leakage capacitance from the total measured capacitance; and
means for processing said thus-calculated capacitance of interest arranged to deliver an information of detection of said object or objects of interest.

12. The device according to claim 11, characterised in that it further includes a substantially planar surface comprising a plurality of measurement electrodes.

13. The device according to claim 11, characterised in that the measurement electrodes comprise a material substantially transparent to light.

14. A system of one of the following categories:
phone, computer, computer peripheral, display screen, dashboard, control panel, configured for implementing a capacitive detection method according to claim 1.

15. A system of one of the following categories: phone, computer, computer peripheral, display screen, dashboard, control panel, comprising a gesture interface device according to claim 11.
